(19) United States
(12) Patent Application Publication
(10) Pub. No.: US 2003/0098326 A1
(43) Pub. Date: May 29, 2003

(54) Bag dispensing rack

(76) Inventor: Richard M. Wile, Medfield, MA (US)

Correspondence Address: PERKINS, SMITH & COHEN LLP, ONE BEACON STREET, 30TH FLOOR, BOSTON, MA, 02108, US

(21) Appl. No.: 10/299,418

(22) Filed: Nov. 19, 2002

Related U.S. Application Data
(60) Provisional application No. 60/332,618, filed on Nov. 23, 2001.

(51) Int. Cl. B26F 3/02

(52) U.S. Cl. 225/77

(57) ABSTRACT

A rack for dspensing rolled plastic bags from a rack, which can be mounted in a variety of positions throughout a store. The rack is formed so that it will support a roll of bags while maintaining friction between the roll of bags and a fixed surface, as the bags are unrolled by the user. The rack is formed so that the friction between the roll of bags and the fixed surface increases as the size of the roll decreases; thus as inertia decreases, friction increases, keeping resistance to unrolling within a specific range. The roll of bags is supported on a support of the rack by either; a single sided arm which rotates around a fixed point and passes through the core of the roll of bags, acting as an axle for the roll; or a double sided arm, which rotates around a fixed point, and supports the core of the roll of bags on both sides of the roll. Both embodiments also have a means for separating one bag from the next, and for keeping the unrolling bags aligned to the means of separation, as the user pulls on the roll of bags to dispense the bags.

### CROSS REFERENCE TO RELATED APPLICATIONS

This application claims priority of U.S. Provisional Application Serial No. 60/332,618, filed Nov. 23, 2001, entitled Method and Means of Dispensing Rolled Plastic Bags, and which is incorporated herein by reference.

### BACKGROUND OF THE INVENTION

This invention relates generally to the holding and dispensing of rolled plastic bags, and more particularly to a rack which holds and dispenses T-shirt type rolled plastic bags in a convenient, yet out of the way position in various places in a store.

The prior art discloses a number of systems, which allow for mounting and dispensing plastic roll bags. Examples of such dispensing racks and systems are disclosed in U.S. Pat. Nos. 5,135,146; 5,261,585; 5,433,363; 5,558,262; 5,219,424; 5,752,666; 5,573,168; 5,813,585; 5,556,019; 5,934,535.

There are two central features in all the dispensing racks in the above mentioned patents. The first feature is the method of trying to get even resistance to unrolling so that the bags do not unroll too freely, with the resistance being in a constant manner throughout the roll. The second common feature is the method of causing the bags to separate from each other as they are dispensing.

In the case of U.S. Pat. Nos. 5,573,168 and 5,813,585, there is very little friction afforded by these designs and the rolls unrolled too easily. This results in the “toilet paper” effect where the user can get more than one bag.

In the case of U.S. Pat. Nos. 5,135,146, 5,433,363, and 5,219,424 improvements have been added, but the friction is constant throughout the roll and does not increase as the roll mass decreases. This results in a varying amount of pull being needed as the roll size changes. Again, this can result in the user getting more or less bags than they wish.

In the case of U.S. Pat. Nos. 5,261,585, 5,556,019, 5,558,262, 5,752,666, and 5,934,535, varying degrees of success have been attained in controlling the level and rate of friction.

It is an object of the present invention to provide a rack which will dispense plastic bags on a roll from various convenient positions in a grocery store.

It is a further object of this invention to provide a rack which will dispense T-shirt style plastic bags on a roll.

It is still a further object of this invention to provide a rack which is small and versatile, so that it will accommodate the dispensing of bags in many different situations in a store.

It is an even further object of this invention to provide a rack which applies variable friction to the roll of bags so that the resistance to unrolling is substantially constant throughout the unrolling of the bags.

It is a still further object of this invention to provide a rack which separates a bag from the roll as the user pulls the bag from the roll.

It is an even further object of this invention to keep the bags aligned to the separating device as the bags are unrolled.

### BRIEF SUMMARY OF THE INVENTION

The present invention takes a novel approach and avoids the use of predetermined guide paths in the sides of the rack to guide the core so that the roll of bags attempts to stay in contact with a fixed surface of the rack. By having a moveable arm determining the guide path, the roll follows an ever steeper path as the roll unwinds, and the fixed surface, against which the roll rests, does not need to be in a fixed plane. This results in a simple method of maintaining a constant level of resistance throughout the roll.

The present invention includes a pivotable swing arm within the rack which is used to hold the roll as it unwinds the bags therefrom. In addition a bag separating mechanism is used in conjunction with the swing arm as the bags are being unwound therefrom. The present invention can be used with the new improved T-shirt type bags which also includes handles. Like past bags, it is folded over on itself and then wound in a roll, with perforations between adjacent bags.

### BRIEF DESCRIPTION OF THE SEVERAL VIEWS OF THE DRAWING

These and other objects, features, and advantages of the invention will best be understood with the aid of the following detailed description in conjunction with the accompanying drawings in which:

FIG. 1. illustrates a rack with a single sided swivel arm;

FIG. 2 illustrates a single sided swivel arm rack, loaded with a roll of bags;

FIG. 3 illustrates a single sided swivel arm rack, loaded with a nearly empty roll of bags;

FIG. 4 illustrates an alternative rack with a double sided swivel arm;

FIG. 5 illustrates a double sided swivel arm rack loaded with a roll of bags;

FIG. 6 illustrates a catch hook with a bag guide;

FIG. 7 illustrates an alternative catch hook with bag guides;

FIG. 8 illustrates an alternative catch hook;

FIG. 9 illustrates an alternative rack, with a single sided swivel arm.

FIG. 10 illustrates a side view of FIG. 9.

FIG. 11 illustrates an underside view of FIG. 9.

FIG. 12 illustrates an alternative rack, with a single sided swivel arm.

FIG. 13 illustrates a side view of FIG. 12.

FIG. 14 illustrates a segmented view of the rack showing the catch hook in FIG. 12.

### DETAILED DESCRIPTION OF THE INVENTION

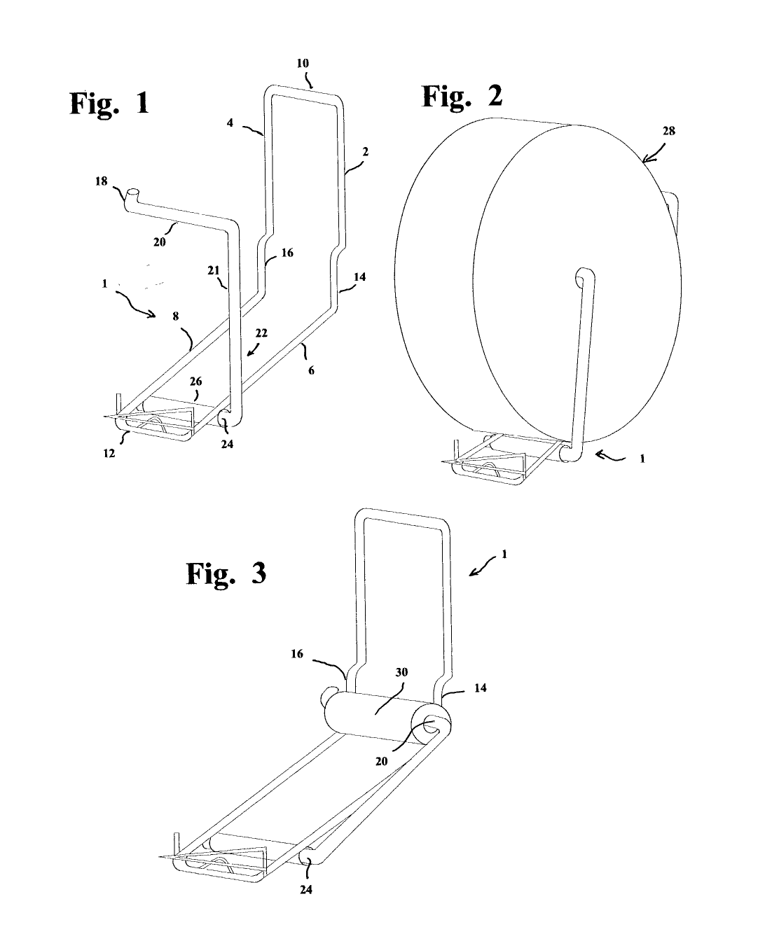

Reference is made to FIG. 1, shich shows a support with two sides 2, 14, 6 and 4, 16, 8, with ends 10 and 12. The sides 2 and 4 are roughly perpendicular to sides 6 and 8. The area described by 2, 4, 14, 16, and 10 form the back of the rack 1, while the side described by 6, 8 and 12, form the bottom. The indentations 14 and 16 are roughly parallel to 2 and 4, and function so that as the roll gets smaller, the roll remains in contact with the back of the rack without touching the bottom. Various other dimensions of the back, rods 2, 4, 14, and 16 and U-shaped pivotable rod or swing arm 22, could be used so that it is unnecessary to have the indentations 14 and 16. This illustration is but one embodiment of the invention. Connected to the bottom, (rods 6 and 8) is a tube 26, which forms the collar (pivot point) into which the swing arm, 22, fits. The swing arm, 22, is a U-shaped device defined by rods 18, 20, 21 and 24. Rod 24 is the axle, which fits into the tube 26. Rod 21 is perpendicular to rod 24 and rod 20 is perpendicular to rod 21. Another 90 degree turn forms side 18, which is used to hold the roll of bags, 28 (FIG. 2), onto the other axle, rod 20. Therefore, the swing arm has two axles, 24, which is the pivot point for the swing arm, and 20, which acts as an axle for the roll of bags, 28.

FIG. 2 shows the rack 1 of FIG. 1 with a roll of bags 28, mounted on it.

FIG. 3 shows the swing arm 22 in a lower position after nearly all the bags 30, have been unrolled from the roll. At such time, the swing arm 22 has pivoted around the lower axle 24, to a nearly horizontal position, with the remaining bags pinched between the upper axle 20 and the frame portion or rods 14 and 16. A feature of this rack 1 is its ability to keep the roll of bags touching a fixed surface of the rack, rods 2, 4, 14, and 16 (FIG. 1). This provides a friction surface and causes resistance to unrolling. As the roll gets smaller, the angle of decline increases, which increases the friction. Therefore, as the mass of the roll of bags decreases, the resistance increases, and the inertia against unrolling remains relatively constant.

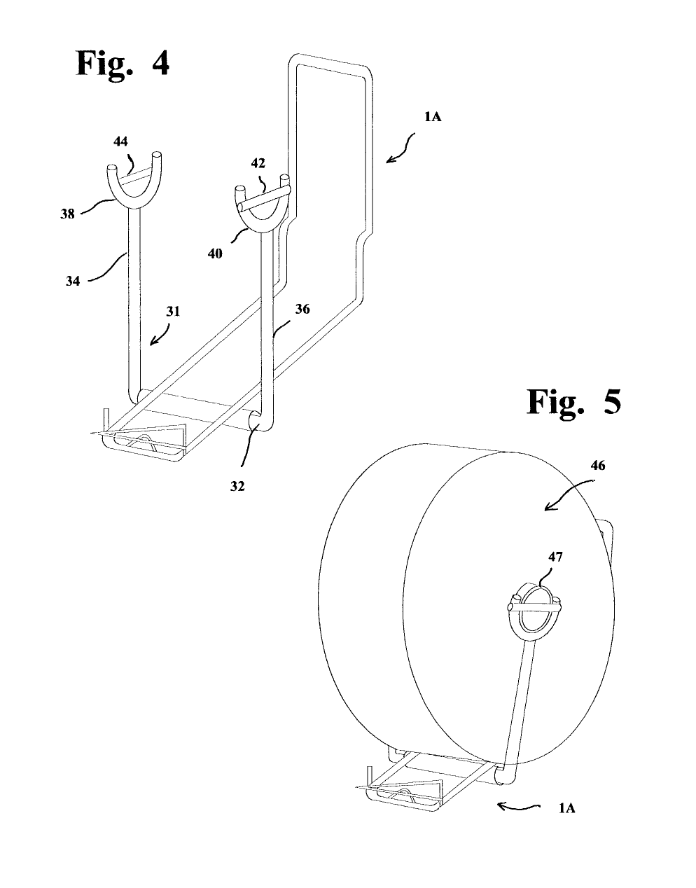

FIG. 4 shows an alternative embodiment of the rack 1A of this invention with a different type of swing arm 31. In this instance, the arm 31 does not have an upper axle, but has a means to support and hold the core at the center of the roll of bags. The double sided swing arm 31 is formed by a U-shaped member, comprising the axle 32 and two parallel side arms 34 and 36, which are perpendicular to the axle 32. At the ends of each side arm there is an apparatus for holding the core of the roll of bags 46 (FIG. 5). The parts 38 and 40 are roughly U-shaped, with an inside dimension only slightly larger than that of the outside dimension of the core 47 (FIG. 5) of the roll of bags, 46. The rods 42 and 44 hold the core centered to the rack 1A, preventing the core from sliding laterally and falling out of one side or the other. The remainder of the rack parts in FIGS. 4 and 5 are the same as those shown in FIG. 1.

FIG. 5 shows the rack 1A (FIG. 4) with a roll of bags 46, mounted on it.

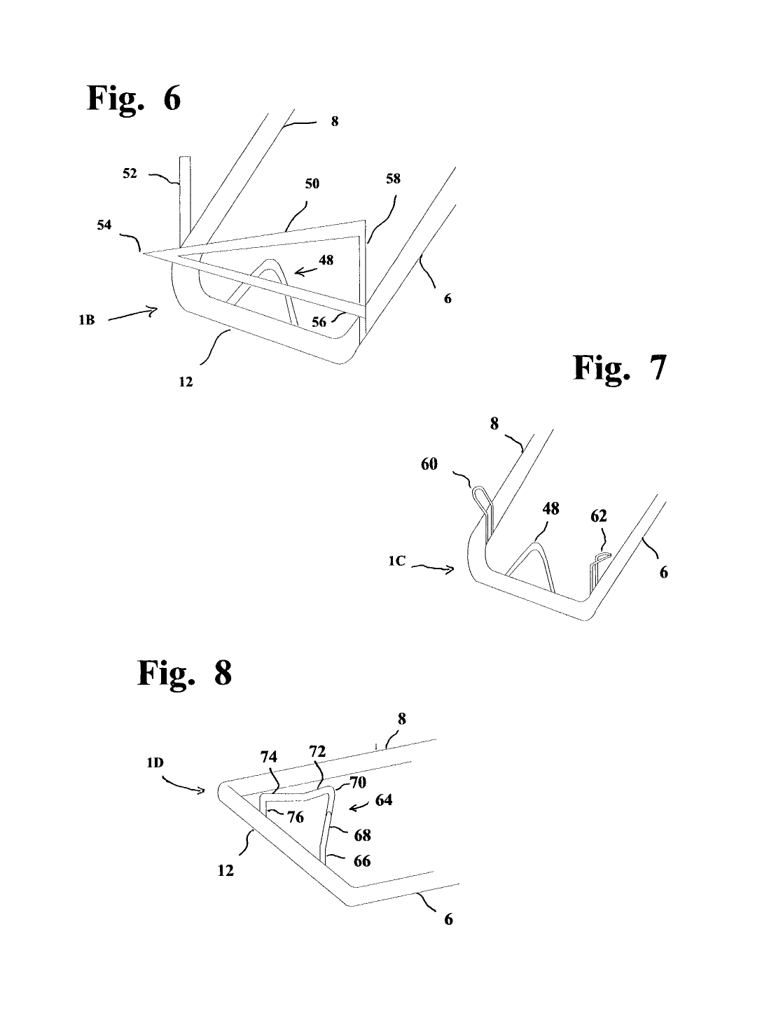

FIG. 6 depicts an embodiment of the rack 1B of this invention illustrating the apparatus which controls the flow and separation of the unrolling bags. These pieces hold the unrolling bags in position so that the bags flow across a member which catches the partially perforated area between the bags and causes the bags to separate. The catch hook 48 rises slightly higher than the plane formed by rods 6 and 8 and catches the cut area between the bags, holding back the trailing bag causing the first bag, which the user is pulling, to tear off. After a person has placed a roll of bags on the swivel arm with the bags unrolling out from under the roll, he or she draws the first bag downward and to the left across the top of rod 50 until the whole bag is pulled tightly against the inside edge of rod 52. The user then pulls the bags downward, around the outside end of rod 50, point 54, and then pulls the bag forward and to the right until it flattens out under the rod 56. The rod 56 is in a plane higher than rods 6 and 8, but lower than the upper point of the catch hook 48. The inside edges of rods 52 and 58 restrict the lateral movement of the unrolling bags, keeping the unrolling bags aligned with the catch hook, 48. The hold down rod, 56, forces the cut between the bags to catch on the catch hook 48, regardless of whether the user pulls downward or upward. By having the end point of rods 50 and 56, point 54, to the outside of rod 52, the bags remain locked within the confines of the area bordered by rods 52, 58, 12, and 56. The rod 52 is perpendicular to the rod 8 and slightly behind the plane of rods 50 and 56. The rod 58 is perpendicular to rod 6, and in the same plane as rod 50 and 56. The catch hook, 48, is obliquely mounted, pointing upward and to the rear, forming an inverted V. The apparatus in FIG. 6 can be used with either the single sided swivel arm rack or the alternative double sided swivel arm rack.

FIG. 7 shows a further alternative embodiment of the invention, rack 1C to control the flow and separation of the unrolling bags. The pieces 60 and 62 hold the unrolling bags in a central position so that the bags flow across the catch hook 48. Catch hook 48 catches the partially perforated area between the bags and causes the bags to separate. The catch hook 48 is obliquely pointing upward and to the rear, forming an inverted V and rises slightly higher than the plane formed by rods 6 and 8, and catches the cut area between the bags, holding back the trailing bag causing the first bag, which the user is pulling, to tear off. After a person has placed a roll of bags on the swivel arm, with the bags unrolling out from under the roll, he or she draws the first bag downward into the trough formed by guides 60 and 62. The user then continues to draw the connected bags out from the roll and downward, drawing the connected bags over the catch hook 48, causing the first bag to separate from the remaining roll.

The guides 60 and 62 act as a guide for the unrolling bags, forming constraints for the outer edges of the bags. By keeping the unrolling bags from moving left or right, the user is more likely to draw the bags across the catch hook 48, with the bags successfully catching the catch hook and then separating. The guides 60 and 62 rise perpendicularly to the rods 6 and 8 and then flair outward at approximately a forty five degree angle a distance sufficient to allow the bags to be drawn down between them and ride over the catch hook 48. The rack 1C of FIG. 7 can be used with either the single sided swivel arm rack or the alternative double sided swivel arm rack.

In FIG. 8 we see another embodiment of the invention, rack 1D illustrating a variation of the catch hook which captures the trailing bag more effectively. The catch hook, 64, is one continuous rod with multiple bends. Rod 66 rises perpendicularly from rod 12 and then bends approximately 90 degrees toward the back and inward slightly forming rod 68. Rod 68 then bends approximately 45 degrees upward forming rod 70, which is bent approximately 160 degrees forming the other side of the curve, 72. Rod 72 then bends back to horizontal forming rod 74. Rod 74 is bent 90 degrees downward, forming rod 76, which is perpendicular to rod 12. The catch hook in FIG. 8 can be used with either the single sided swivel arm rack or the alternative double sided swivel arm rack.

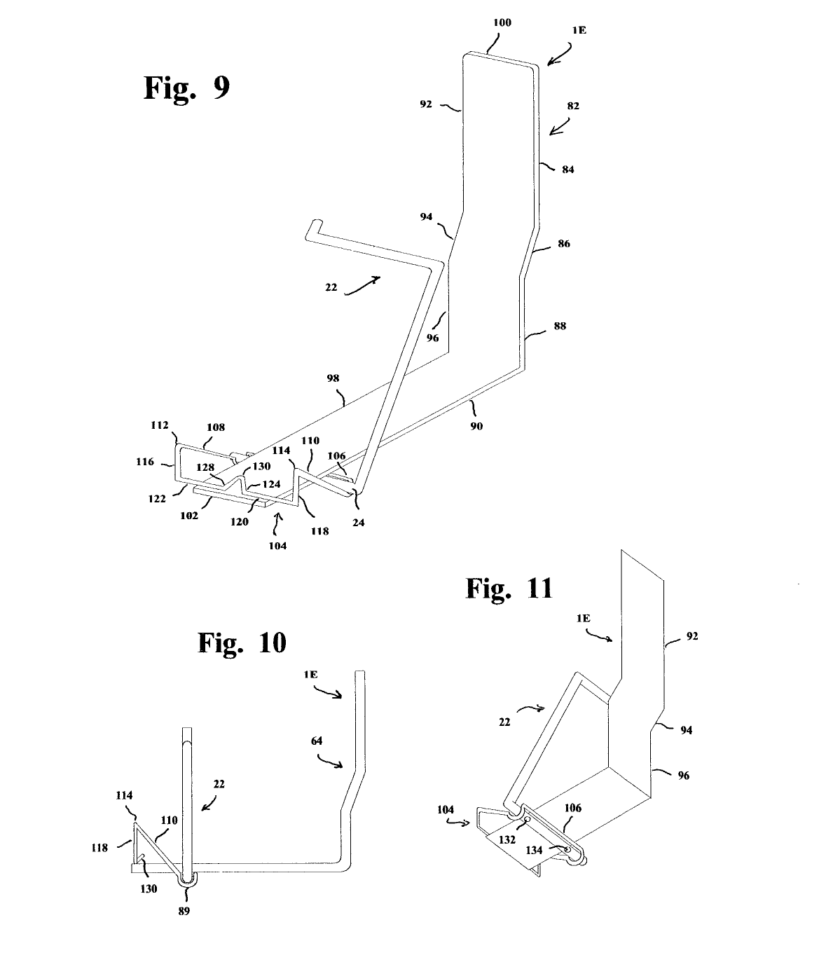

FIG. 9 shows a still further alternative embodiment, rack 1E with a further modified single sided swing arm. The frame, 82, is bounded by sides 84, 86, 88, 90, 92, 94, 96, 98, and ends 100 and 102. The top of the back of the rack is bounded by sides 84 and 92, and the end of the rack, 100. The portion of the back bounded by sides 86 and 94 is angled out toward the front of the rack from the portion formed by 84, 92 and 100. The portion of the back bounded by sides 88 and 96 returns to an approximately parallel plane as the portion bounded by 84, 92, and 100. The bottom of the rack, bounded by sides 90 and 98, and end, 102, is roughly perpendicular to the back portion bounded by sides 88 and 96. The U shaped rod, 22, which is the swing arm, functions similarly to the swing arm in FIG. 1, but is entrapped by the catch hook assembly, 104, instead of a tube (FIG. 1, tube 26), around the lower axle, 24, of the swing arm assembly, 22. The catch hook assembly 104, starts with a rod 106 running parallel to the rod 24, and at its ends bends 90 degrees and wraps around rod 24. (In FIG. 10 we see this bend, 89). Exiting the bend, the rods extend obliquely up toward the front of the rack forming approximately parallel rods 108 and 110. Rods 108 and 110 then bend downward at points 112 and 114, forming rods 116 and 118, extending until they reach the plane formed by the bottom of the rack frame bounded by sides 90 and 98. At this point, rods 116 and 118 turn inward 90 degrees, forming rods 120 and 122. As rods 120 and 122 converge, each is bent obliquely upward, inward, and to the rear at points 124 and 128 until they meet at point 130, thus forming an inverted V pointing obliquely upward and to the rear.

In FIG. 10, rack 1E, of FIG. 9 is shown in a side view.

FIG. 11 is an underside view of the rack 1E of FIG. 9 and illustrates two balls, 132 and 134, whose function is to lock the swing arm, 22, within the confines of the catch hook assembly, 104, and to restrict the forward motion of the swing arm, 22. The two balls, 132 and 134, come in contact with rod 106 when the swing arm 22 is just forward of vertical.

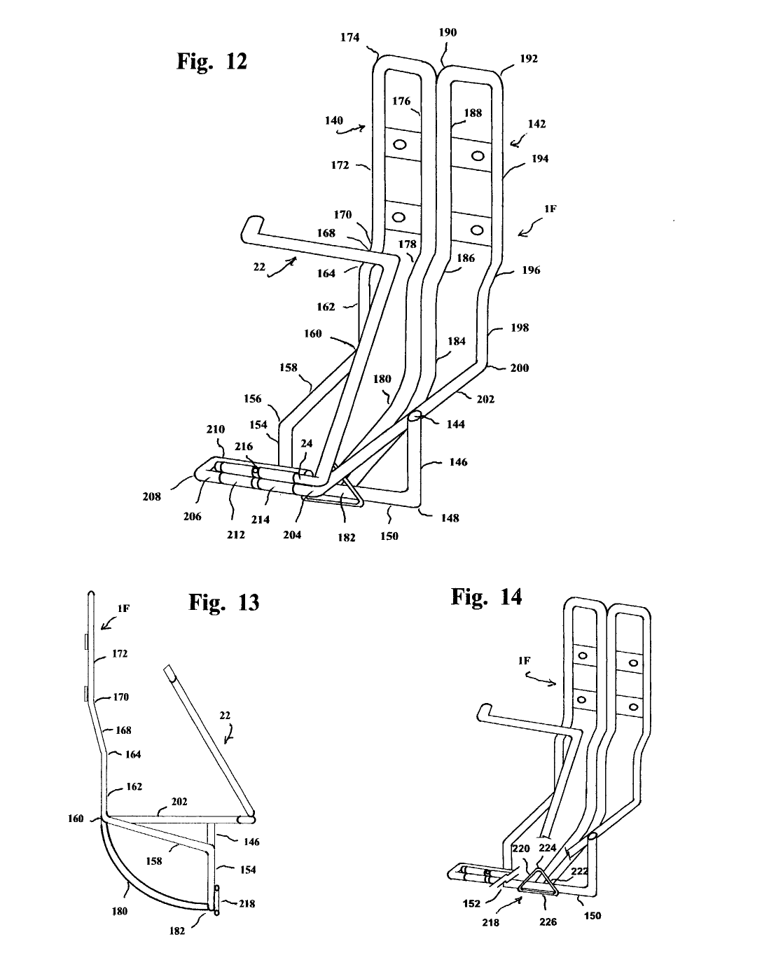

FIGS. 12 and 13 illustrate another variation of this invention in the form of modified swing arm rack 1F. This variation dispenses the bags in a downward direction, rather than toward the front as with the previously described racks. The support is comprised of a left side 140, and a right side, 142, each with multiple bends. Side 140 begins at point 144, with rod 146, which goes down vertically to point 148 and bends 90 degrees forming rod 150. Rod 150 travels to the other side of the rack and bends 90 degrees upward, at point 152, (FIG. 12), forming rod 154. Rod 154 rises approximately vertically to point 156, where it bends toward the back at an angle less than 90 degrees from vertical. This forms rod 158, which extends to the point 160, where it bends to approximately vertical, forming rod 162. Rod 162 rises vertically to point 164, where it bends roughly 45 degrees toward the back, forming rod 168. Rod 168 extends to point 170, where it bends toward vertical, forming rod 172. Rod 172 extends upward to point 174 where it bends 180 degrees and descends vertically, forming rods 176 and 178, which are parallel to, and in the same plane as, rods 172 and 168. At this point rod 180 is formed as a continuous curve terminating at point 182. The right side of the frame, 142, begins at point 182 and forms rods 184, 186 and 188, which are duplicates of rods 180, 178 and 176, at the end of which it bends 180 degrees from point 190 to 192. It then descends, forming rods 194, 196 and 198, which are duplicates of rods 172, 168 and 162. At the end of rod 198, point 200, the rod bends 90 degrees, forming rod 202, and runs to the front of the rack, point 204, where it bends 90 degrees, forming rod 206. Rod 206 runs to point 208, where it bends 180 degrees, forming rod 210. Rod 210 runs to the right side of the rack and terminates. The swivel point axle, 24, of the swing arm, 22, is secured to rod 206 by use of two welded slip clips, 212 and 214. A welded ball, 216, in between slip clips 212 and 214 prevents the swing arm, 22, from sliding left or right and prevents the swing arm, 22, from moving forward of vertical when the ball, 216, comes in contact with rod 206. It is the gap between rod 210 and the point 156, which simplifies the loading of the rack with bags. After loading the bags on the swing arm, 22, the user simply pulls the unrolling bags down between rod 210 and point 156 and over the catch hook, point 224, (FIG. 14). The rack 1F is then ready to dispense bags.

FIG. 13 illustrated s a left side view of FIG. 12.

FIG. 14 shows a segmented view of FIG. 12 showing the catch hook, 218, which catches the opening between the bags and causes the trailing bag to remain behind while the lead bag tears away. The catch hook, 218, is aligned approximately vertical, as shown in FIG. 15, and is attached to rod 150. There are two required sides, rods 220 and 222, which meet at approximately 45 degrees at point 224. The rod 226 is optional and functions only to avoid open sharp ends on rods 220 and 222.

Although the invention has been described with respect to various embodiments, it should be realized this invention is also capable of a wide variety of further and other embodiments within the spirit and scope of the appended claims.

What is claimed is:

1. A bag dispensing rack for use with bags, attached to each other and having perforations therebetween, wound on a roll, the rack comprising:
a support, said support having a bottom and a back;
a swing arm, said swing arm having a portion thereof capable of rotatably supporting the roll of bags;
means operably connected to said support for pivotally mounting said swing arm thereto such that that said swing arm is capable of pivotable motion with respect to said support as the bags are unwound from the roll of bags during a bag dispensing operation;
said swing arm being of such size to enable the roll of bags to bear against a portion of said support during the dispensing operation; and
means operably associated with said support for separating individual bags from one another as the bags are being dispensed from the rack and the perforations are drawn against said separating means;
whereby the bags are capable of being dispensed from the rack in an orderly fashion.

2. The bag dispensing rack as defined in claim 1 wherein said swing arm comprises a top portion which is capable of passing through a core of the roll and about which the roll rotates as the bags are dispensed.

3. The bag dispensing rack as defined in claim 1 wherein said swing arm has a pair of spaced apart side members, each of said side members having means thereon for engaging ends of a core of the roll and enabling the roll to rotate as the bags are being dispensed.

4. The bag dispensing rack as defined in claim 1 wherein said swing arm being of such size to enable the roll of bags to bear against a portion of at least said back of said support during the dispensing operation.

5. The bag dispensing rack as defined in claim 1 wherein said swing arm being of such size to enable the roll of bags to bear against a portion of at least said bottom of said support during the dispensing operation.

6. The bag dispensing rack as defined in claim 1 wherein said bag separating means comprises a triangular-shaped member located at a front end of said support and wherein the bags, as they are being unrolled from the roll on said swing arm pass, over the a portion of said triangular-shaped member for separation of the bags.

7. The bag dispensing rack as defined in claim 6 further comprising a pair of guides, each of said guides being located at opposite sides of said bottom of said support adjacent said separating means for guiding the bags from the roll as the bags are being dispensed.

8. The bag dispensing rack as defined in claim 6 wherein said bag separating means further comprises a pair of indented members at said front end of said support terminating in said triangular-shaped member.

9. The bag dispensing rack as defined in claim 2 wherein said swing arm is made up of said top portion, a side portion and a bottom portion, said top portion being positioned substantially perpendicular to said side portion and said bottom portion being substantially perpendicular to said side portion and said top portion and said bottom portion being substantially parallel to each other.

10. The bag dispensing rack as defined in claim 9 further comprising means associated with said bottom of said support for pivotally supporting said bottom portion of said swing arm therein and means associated with said swing arm for restricting the movement of said swing arm.

11. The bag dispensing rack as defined in claim 10 further comprises a hold down member operably associated with said bag separating means for maintaining the bags in contact with said bag separating means as the bags are unrolled from the roll.

12. The bag dispensing rack as defined in claim 10 wherein said bag separating means and said means for pivotally supporting said bottom portion of said swing arm therein are made of a substantially unitary construction.

13. The bag dispensing rack as defined in claim 11 further comprises a hold down member operably associated with said bag separating means for maintaining the bags in contact with said bag separating means as the bags are unrolled from the roll.

14. A bag dispensing rack for use with bags, attached to each other and having perforations therebetween, wound on a roll, the rack comprising:
a support, said support being of a frame-like configuration having a side portion, a bottom portion and an intermediate portion;
a swing arm, said swing arm having a portion thereof capable of rotatably supporting the roll of bags;
means operably connected to said intermediate portion of said support for pivotally mounting said swing arm thereto such that that said swing arm is capable of pivotable motion with respect to said support as the bags are unwound from the roll of bags during a bag dispensing operation;
said swing arm being of such size to enable the roll of bags to bear against a portion of said support during the dispensing operation; and
means operably associated with said bottom portion of said support for separating individual bags from one another as the bags are being dispensed from the rack and the perforations are drawn against said separating means;
whereby the bags are capable of being- dispensed from the rack in an orderly fashion.

15. The bag dispensing rack as defined in claim 14 wherein said swing arm comprises top portion which is capable of passing through a core of the roll and about which the roll rotates as the bags are dispensed.

16. The bag dispensing rack as defined in claim 14 wherein said swing arm is made up of said top portion, a side portion and a bottom portion, said top portion being positioned substantially perpendicular to said side portion and said bottom portion being substantially perpendicular to said side portion and said top portion and said bottom portion being substantially parallel to each other.

17. A bag dispensing rack for use with bags, attached to each other and having perforations therebetween, wound on a roll, the rack comprising:
a support;
a swing arm, said swing arm having a portion thereof capable of rotatably supporting the roll of bags;
means operably connected to said support for pivotally mounting said swing arm thereto such that that said swing arm is capable of pivotable motion with respect to said support as the bags are unwound from the roll of bags during a bag dispensing operation;
said swing arm being of such size to enable the roll of bags to bear against a portion of said support during the dispensing operation;
means operably associated with said support for separating individual bags from one another as the bags are being dispensed from the rack and the perforations between the bags are drawn against said separating means; and
a pair of guides, each of said guides being located at opposite sides of said support adjacent said separating means for guiding the bags from the roll as the bags are being dispensed.
whereby the bags are capable of being dispensed from the rack in an orderly fashion.

18. The bag dispensing rack as defined in claim 17 wherein said swing arm comprises top portion which is capable of passing through a core of the roll and about which the roll rotates as the bags are dispensed.

19. The bag dispensing rack as defined in claim 17 wherein said swing arm has a pair of spaced apart side members, each of said side members having means thereon for engaging ends of a core of the roll and enabling the roll to rotate as the bags are being dispensed.

20. The bag dispensing rack as defined in claim 17 wherein said bag separating means comprises a triangular-shaped member located at a front end of said support and wherein the bags as they are being unrolled from the swing arm pass over the top portion of said triangular-shaped member for separation of the bags.
